(19) United States
(12) Patent Application Publication
(10) Pub. No.: US 2022/0198216 A1
(43) Pub. Date: Jun. 23, 2022

(54) COMPUTER-READABLE RECORDING MEDIUM STORING IMAGE OUTPUT PROGRAM, IMAGE OUTPUT METHOD, AND IMAGE OUTPUT APPARATUS

(71) Applicant: FUJITSU LIMITED, Kawasaki-shi (JP)

(72) Inventor: Kota ANADA, Kawasaki (JP)

(73) Assignee: FUJITSU LIMITED, Kawasaki-shi (JP)

(21) Appl. No.: 17/507,833

(22) Filed: Oct. 22, 2021

(30) Foreign Application Priority Data
Dec. 17, 2020 (JP) 2020-209443

(51) Int. Cl. G06K 9/62; G06T 11/00; G06N 3/04

(52) U.S. Cl. CPC G06K 9/6215; G06N 3/04; G06T 11/00; G06K 9/6232

(57) ABSTRACT

A process includes inputting a first image to a machine learning model, acquiring a feature amount of the first image and a first estimation result by the model to which the first image is input, selecting at least one second image from a plurality of images, based on the feature amount, inputting the second image to the model, acquiring a second estimation result by the model to which the second image is input, generating, based on the first image and the first estimation result, a third image that indicates an area of the first image that contributes to the first estimation result more than other areas, generating, based on the second image and the second estimation result, a fourth image that indicates an area of the second image that contributes to the second estimation result more than other areas, and outputting the third image and the fourth image.

### CROSS-REFERENCE TO RELATED APPLICATION

This application is based upon and claims the benefit of priority of the prior Japanese Patent Application No. 2020-209443, filed on Dec. 17, 2020, the entire contents of which are incorporated herein by reference.

### FIELD

The embodiments discussed herein are related to a computer-readable recording medium storing an image output program, an image output method, and an image output apparatus.

### BACKGROUND

For example, an existing design material or the like may be referred to in order to create or design an estimate in operation maintenance development of a system.

In the related art, a user performs search with respect to a shared folder of a server or the like based on a folder configuration, a file name, or the like to acquire a target document such as a design material.

In recent years, there has also been known a method of crawling a document to perform a natural sentence search, thereby making it possible to acquire a document that includes a search sentence even without knowledge of a storage location and a folder configuration in a shared folder.

Japanese Laid-open Patent Publication No. 2007-317131, Japanese Laid-open Patent Publication No. 2008-083898, and Japanese Laid-open Patent Publication No. 2008-146602 are disclosed as related art.

### SUMMARY

According to an aspect of the embodiments, a non-transitory computer-readable recording medium storing an image output program that causes a computer to execute a process, the process includes inputting a first image to a machine learning model to estimate image data, acquiring a feature amount of the first image and a first estimation result by the machine learning model to which the first image is input, selecting at least one second image from a plurality of images, based on the feature amount of the first image, inputting the second image to the machine learning model, acquiring a second estimation result by the machine learning model to which the second image is input, generating, based on the first image and the first estimation result, a third image that indicates an area of the first image that contributes to the first estimation result more than other areas, generating, based on the second image and the second estimation result, a fourth image that indicates an area of the second image that contributes to the second estimation result more than other areas, and outputting the third image and the fourth image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing apparatus as an example of an embodiment;

FIG. 2 is a diagram exemplifying a hardware configuration of the information processing apparatus as the example of the embodiment;

FIG. 3 is a diagram exemplifying information managed by an image DB of the information processing apparatus as the example of the embodiment;

FIG. 4 is a diagram exemplifying presentation information in the information processing apparatus as the example of the embodiment;

FIG. 5 is a flowchart for explaining processing of a document registration processing unit in the information processing apparatus as the example of the embodiment;

FIG. 6 is a flowchart for explaining document search processing in the information processing apparatus as the example of the embodiment; and

FIG. 7 is a flowchart for explaining processing by an explainable AI unit in the information processing apparatus as the example of the embodiment.

### DESCRIPTION OF EMBODIMENTS

In a document search method of the related art, since it is desired to input a natural sentence as a search sentence, for example, in a case where it is desired to search a document including specific screen data (for example, a user interface screen or a graph), the search may not be easily performed. Therefore, it is considered to search for a similar image by using an image as a search key. However, even when the similar image is specified by a search using the image as the search key, there is a problem that it is not possible to present which area of the image the image is determined to be similar.

Hereinafter, an embodiment of a technique capable of presenting which area of the image an estimation result by a machine learning model is based on will be described. However, the following embodiment is merely an example and does not intend to exclude application of various modification examples and techniques that are not explicitly described in the embodiment. For example, the present embodiment may be variously modified and implemented without departing from the spirit of the embodiment. Each drawing does not indicate that only constituent components illustrated in the drawings are provided. The drawings indicate that other functions and the like may be included.

(A) Configuration

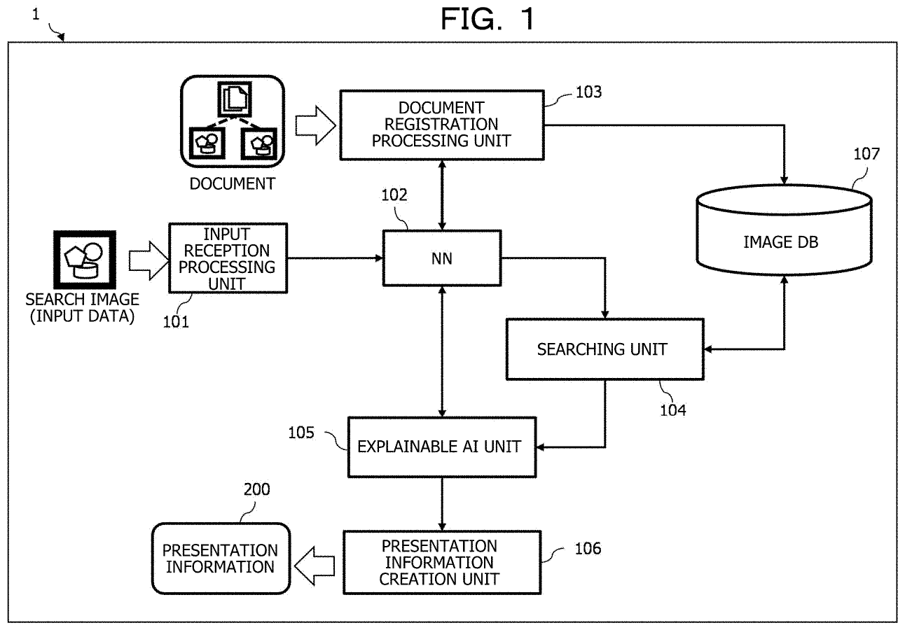

FIG. 1 is a diagram schematically illustrating a configuration of an information processing apparatus 1 as an example of the embodiment.

The information processing apparatus 1 searches for and presents data including data similar to data that has been input (input data). For example, the information processing apparatus 1 implements a search function using the input data as a search key. The information processing apparatus 1 also implements Explainable Artificial Intelligence (XAI) presenting information explaining a basis for similarity determination to the user.

An example in which the input data input as the search key is image data and the information processing apparatus 1 searches for a document that includes image data similar to the input image data will be described below.

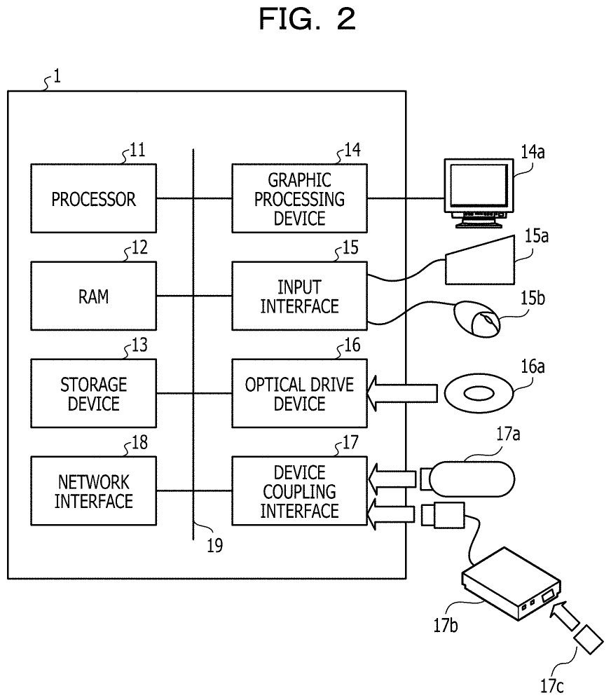

FIG. 2 is a diagram exemplifying a hardware configuration of the information processing apparatus 1 as the example of the embodiment.

The information processing apparatus 1 includes, for example, a processor 11, a memory 12, a storage device 13, a graphic processing device 14, an input interface 15, an optical drive device 16, a device coupling interface 17, and a network interface 18 as constituent components. These constituent components 11 to 18 are configured so as to be mutually communicable via a bus 19.

The processor (processing unit) 11 controls an entire information processing apparatus 1. The processor 11 may be a multiprocessor. For example, the processor 11 may be any one of a central processing unit (CPU), a microprocessor unit (MPU), a digital signal processor (DSP), an application-specific integrated circuit (ASIC), a programmable logic device (PLD), and a field-programmable gate array (FPGA). The processor 11 may be a combination of two or more types of elements of the CPU, the MPU, the DSP, the ASIC, the PLD, and the FPGA.

The processor 11 executes a control program (image output program: not illustrated) for the information processing apparatus 1, thereby implementing functions as an input reception processing unit 101, a neural network (NN) 102, a document registration processing unit 103, a searching unit 104, an explainable artificial intelligence (AI) unit 105, a presentation information creation unit 106, and an image database (DB) 107 illustrated in FIG. 1. Thus, the information processing apparatus 1 functions as an image output apparatus.

A program describing a content of processing executed by the information processing apparatus 1 may be recorded in various recording media. For example, the program executed by the information processing apparatus 1 may be stored in the storage device 13. The processor 11 loads at least a part of the program in the storage device 13 into the memory 12 and executes the loaded program.

The program executed by the information processing apparatus 1 (processor 11) may be recorded in a non-transitory portable recording medium, such as an optical disc 16a, a memory device 17a, and a memory card 17c. For example, the program stored in the portable recording medium may be executed after being installed in the storage device 13 by control from the processor 11. The processor 11 may read the program directly from the portable recording medium and execute the program.

The memory 12 is a storage memory including a read-only memory (ROM) and a random-access memory (RAM). The RAM of the memory 12 is used as a main storage device of the information processing apparatus 1. In the RAM, at least part of the program executed by the processor 11 is temporarily stored. In the memory 12, various kinds of data desired for the processing by the processor 11 are stored.

The storage device 13 is a storage device such as a hard disk drive (HDD), a solid-state drive (SSD), and a storage class memory (SCM) stores various kinds of data. The storage device 13 is used as an auxiliary storage device of the information processing apparatus 1. The storage device 13 stores an operating system (OS) program, a control program, and various kinds of data. The control program includes an image output program. The control program (image output program) corresponds to a program recorded in a computer-readable non-transitory recording medium.

As the auxiliary storage device, a semiconductor storage device, such as the SCM and a flash memory, may be used. A plurality of storage devices 13 may be used to constitute redundant arrays of inexpensive disks (RAID).

The storage device 13 may store various kinds of data generated when the above-described input reception processing unit 101, the neural network 102, the document registration processing unit 103, the searching unit 104, the explainable AI unit 105, and the presentation information creation unit 106 execute each processing.

A monitor 14a is coupled to the graphic processing device 14. The graphic processing device 14 displays an image on a screen of the monitor 14a in accordance with an instruction from the processor 11. Examples of the monitor 14a include a display device with a cathode ray tube (CRT), a liquid crystal display device, or the like.

A keyboard 15a and a mouse 15b are coupled to the input interface 15. The input interface 15 transmits signals transmitted from the keyboard 15a and the mouse 15b to the processor 11. The mouse 15b is an example of a pointing device, and a different pointing device may be used. Examples of other pointing devices include a touch panel, a tablet, a touch pad, a track ball, or the like.

The optical drive device 16 reads data recorded in the optical disc 16a by using laser light or the like. The optical disc 16a is a portable non-transitory recording medium in which data is recorded so that the data is readable using light reflection. Examples of the optical disc 16a include a Digital Versatile Disc (DVD), a DVD-RAM, a compact disc read-only memory (CD-ROM), a CD-recordable (R), a CD-rewritable (RW), or the like.

The device coupling interface 17 is a communication interface for coupling peripheral devices to the information processing apparatus 1. For example, the memory device 17a or a memory reader-writer 17b may be coupled to the device coupling interface 17. The memory device 17a is a non-transitory recording medium equipped with a function of communicating with the device coupling interface 17 and is, for example, a Universal Serial Bus (USB) memory. The memory reader-writer 17b writes data to the memory card 17c or reads data from the memory card 17c. The memory card 17c is a card-type non-transitory recording medium.

The network interface 18 is coupled to a network. The network interface 18 transmits and receives data via the network. Other information processing apparatuses, communication devices, or the like may be coupled to the network.

As illustrated in FIG. 1, the information processing apparatus 1 includes the input reception processing unit 101, the neural network 102, the document registration processing unit 103, the searching unit 104, the explainable AI unit 105, the presentation information creation unit 106, and the image DB 107.

The document registration processing unit 103 registers information related to a document that includes image data in the image DB 107. The document registration processing unit 103 extracts the image data from the document and causes a feature amount (feature amount vector) to be calculated with respect to the extracted image data by using a machine learning model of the neural network 102. The extraction of the image data from the document may be implemented by using a known method, and the description thereof will be omitted. The document registration processing unit 103 causes the image DB 107 to store the calculated feature amount and information such as the file name and the storage position of the document that includes the image. The image DB 107 is a database that manages information related to the image data.

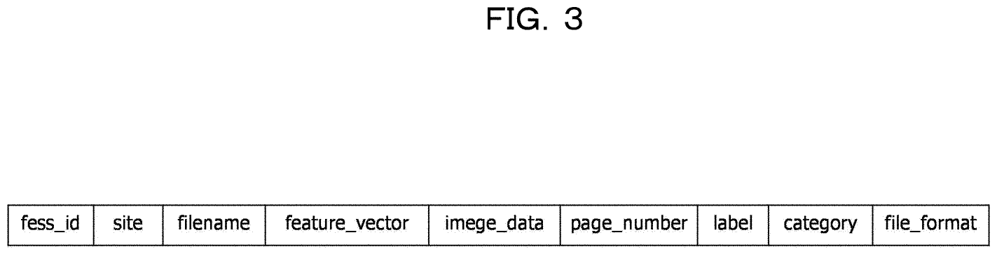

FIG. 3 is a diagram exemplifying the information managed by the image DB 107 of the information processing apparatus 1 as the example of the embodiment. In the example illustrated in FIG. 3, the image DB 107 indicates entries managed for each image data. The entries exemplified in FIG. 3 include fess_id, site, filename, feature_vector, image_data, page_number, label, category, and file_format. The image DB 107 manages the entries composed of these pieces of information for each image data.

The fess_id is identification information for managing a document that includes the image data, and is set by a search engine, for example. The site is a storage location of the document, and for example, a file path is used. The filename is a file name of the document. The feature_vector is a feature amount (feature amount vector) of the image, and a value calculated by the neural network 102 is used.

The image_data is binary data of the image data. The page_number is information that indicates a position (for example, a page number) of the image data in the document. The label is a label (prediction result) set by the neural network 102 for the image. For example, a value that indicates the presence or absence of a problem is used.

The category is a keyword that indicates an image type of the image data. The file_format is a data format (for example, jpeg and png) of the image data.

The neural network 102 performs estimation on the input image data by using a machine learning model. The neural network 102 is, for example, a deep neural network that includes a plurality of hidden layers between an input layer and an output layer. Examples of the hidden layers include, for example, a convolution layer, a pooling layer, a fully coupled layer, or the like.

The neural network 102 inputs the input data (image data in the present embodiment) to the input layer, and sequentially executes predetermined calculations in the hidden layers that include the convolution layer, the pooling layer, or the like, thereby executing processing in a forward direction (forward propagation processing) in which information obtained by the computations are sequentially transmitted from the input side to the output side. After the processing in the forward direction is executed, the neural network 102 executes processing in a backward direction (back propagation processing) of determining parameters used in the processing in the forward direction for reducing a value of an error function obtained from correct answer data and output data output from the output layer. Update processing of updating variables, for example, a weight, is executed based on the result of the back propagation processing. For example, as an algorithm for determining an update width of the weight used in the calculations in the back propagation processing, gradient descent is used.

As the machine learning model, for example, a known machine-learned model may be used. Fine tuning may be performed on the machine-learned model by performing retraining in advance using training data that includes the image data and the correct answer data.

The neural network 102 calculates a feature amount (feature amount vector) for the input image data. The neural network 102 causes the calculated feature amount or the like of the image data to be stored in a predetermined storage area of the memory 12 or the storage device 13.

The neural network 102 may be a hardware circuit or a virtual network by software that couples layers virtually built over a computer program by the processor 11 or the like.

The input reception processing unit 101 receives image data serving as a search key for searching for a document. Hereinafter, the image data serving as the search key received by the input reception processing unit 101 may be referred to as search image data. The search image data corresponds to a first image. For example, the user may input (designate) the search image data by using the keyboard 15a or the mouse 15b.

The input reception processing unit 101 causes a feature amount (feature amount vector) for the input search image data to be calculated by using the machine learning model of the neural network 102. The input reception processing unit 101 transfers the feature amount of the search image data calculated by the neural network 102 to the searching unit 104. The input reception processing unit 101 may transfer the feature amount of the search image data to the searching unit 104 via, for example, a predetermined storage area of the memory 12 or the storage device 13.

The searching unit 104 searches for image data that has a feature amount similar to that of the search image data from a plurality of pieces of image data registered in the image DB 107, and outputs a document that includes the image data as a search result.

For example, the searching unit 104 calculates a cosine similarity between the feature amount of the search image data and the feature amount of each image data registered in the image DB 107 to perform similarity determination between the feature amount of the search image data and the feature amount of each image data registered in the image DB 107. Hereinafter, performing the similarity determination between the feature amount of the search image data and the feature amount of each image data registered in the image DB 107 may be referred to as image similarity determination.

As a result of the image similarity determination, the searching unit 104 determines a plurality of pieces of image data (similar image data group) that have high similarities (for example, three pieces of image data with higher similarities). The image data that has the high similarity to the search image data determined by the searching unit 104 may be referred to as similar image data. The similar image data corresponds to a second image. Image data that has a similarity to the search image data equal to or greater than a threshold may be set as the similar image data, and the setting of the similar image data may be changed as appropriate.

The searching unit 104 notifies the explainable AI unit 105 of information on the determined plurality of pieces of similar image data. For example, the searching unit 104 notifies the explainable AI unit 105 of a storage location (document path) of each document that includes these pieces of similar image data. The searching unit 104 may notify the explainable AI unit 105 of each information of the entry of the image DB 107 related to each similar image data. The information notification to the explainable AI unit 105 may be performed via a predetermined storage area of the memory 12 or the storage device 13.

The explainable AI unit 105 creates information (visualization information) that makes a process leading to a prediction result or an estimation result in the machine learning model of the neural network 102 explainable for humans. For example, the explainable AI unit 105 implements a determination basis explanation function of the prediction result or the estimation result in the machine learning model of the neural network 102.

The explainable AI unit 105 may create the visualization information by using various known XAI methods. In the present embodiment, the explainable AI unit 105 creates the visualization information by using gradient-weighted class activation mapping (Grad-CAM).

The explainable AI unit 105 acquires the estimation (classification) result and the feature amount of an intermediate layer obtained by inputting the search image data to the neural network 102. The explainable AI unit 105 quantifies determination criterion by obtaining a gradient from the obtained classification result and the feature amount of the intermediate layer, and performs imaging.

Similarly, the explainable AI unit 105 respectively acquires the estimation (classification) result and the feature amount of the intermediate layer obtained by inputting each similar image data to the neural network 102. The explainable AI unit 105 quantifies determination criterion by obtaining a gradient from the obtained classification result and the feature amount of the intermediate layer, and performs imaging.

The explainable AI unit 105 inputs the search image data to the machine learning model of the neural network 102 to acquire a first estimation result. Based on the first estimation result, the explainable AI unit 105 generates a first heat map (third image) that represents a basis of the first estimation result in the search image data by the Grad-CAM. The explainable AI unit 105 causes the generated first heat map to be stored in a predetermined storage area of the memory 12 or the storage device 13.

In the first heat map, an area that contributes to the above-described first estimation result more than other areas in the search image data is indicated by highlighted display using a noticeable color. This highlighted display represents a feature portion on which a convolutional neural network (CNN) in the neural network 102 is focused. A method of generating a heat map by the Grad-CAM is known and the description thereof will be omitted.

The explainable AI unit 105 respectively inputs the plurality of pieces of similar image data selected by the searching unit 104 to the machine learning model of the neural network 102 to acquire a second estimation result.

Based on the second estimation result, the explainable AI unit 105 generates a second heat map (fourth image) that represents a basis of the corresponding second estimation result for each of the plurality of pieces of similar image data by the Grad-CAM. The explainable AI unit 105 causes the generated second heat map to be stored in a predetermined storage area of the memory 12 or the storage device 13. Also in the second heat map, an area that contributes to the above-described second estimation result more than other areas in the search image data is indicated by highlighted display using a noticeable color.

The explainable AI unit 105 transfers the search image data and the first heat map (third image) with respect to the estimation result thereof to the presentation information creation unit 106. The explainable AI unit 105 transfers the plurality of pieces of similar image data and the second heat map (fourth image) with respect to the estimation result thereof to the presentation information creation unit 106.

The presentation information creation unit 106 creates presentation information 200 that presents information of a document that includes the similar image data similar to the input search image data and presents to the user a heat map image for explaining a basis of the similarity determination.

The presentation information 200 represents a search result of the document that includes the similar image data similar to the search image data input as the search key. Hereinafter, the presentation information 200 may be referred to as a search result output screen 200. The presentation information 200 represents information that indicates a basis of the similarity determination performed when determining (estimating) each similar image data.

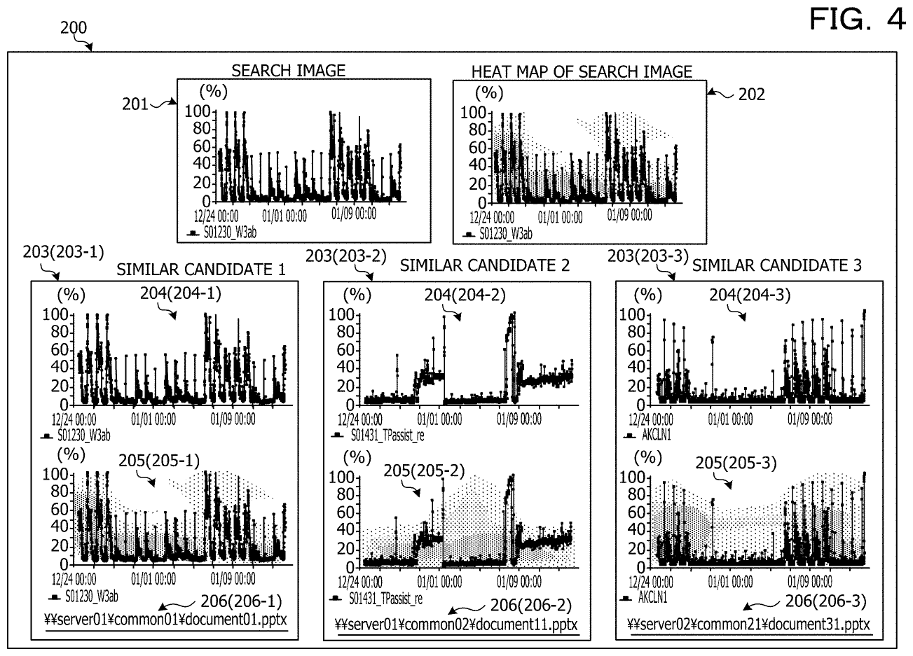

FIG. 4 is a diagram exemplifying the presentation information 200 in the information processing apparatus 1 as the example of the embodiment. The presentation information 200 exemplified in FIG. 4 includes a search image 201, a heat map 202, and similar candidate image information 203-1 to 203-3. The search image 201 indicates the search image data (first image). The heat map 202 is a first heat map (third image) created for the search image data.

The similar candidate image information 203-1 to 203-3 are information related to the similar image data similar to the search image data, respectively, and in the information processing apparatus 1, three pieces of similar image data are represented as similar candidates 1 to 3.

In the example illustrated in FIG. 4, the similar candidate 1 (similar candidate image information 203-1) represents similar image data that has the highest similarity to the search image data. Next, it is assumed that the similarity decreases in an order of the similar candidate 2 (similar candidate image information 203-2) and the similar candidate 3 (similar candidate image information 203-3). For example, in the presentation information 200, the plurality of pieces of similar image data similar to the search image data are represented by being ranked according to the similarity. Hereinafter, the similar candidate image information 203-1 to 203-3 are represented by the similar candidate image information 203 when they are not particularly distinguished.

The similar candidate image information 203-1 includes a similar image 204-1, a heat map 205-1, and a document path 206-1. Similarly, the similar candidate image information 203-2 includes a similar image 204-2, a heat map 205-2, and a document path 206-2. The similar candidate image information 203-3 includes a similar image 204-3, a heat map 205-3, and a document path 206-3.

Hereinafter, the similar images 204-1 to 204-3 are represented by a similar image 204 when they are not particularly distinguished. The heat maps 205-1 to 205-3 are represented by a heat map 205 when they are not particularly distinguished. The document paths 206-1 to 206-3 are represented by a document path 206 when they are not particularly distinguished. The similar images 204-1 to 204-3 are images (second images) of three pieces of similar image data determined by the searching unit 104.

Each of the heat maps 205 is a second heat map (fourth image) corresponding to each similar image data generated by the explainable AI unit 105. In the search result output screen 200, the heat maps 202 and 205 represent the basis for the similarity determination by the machine learning model of the neural network 102.

Each of the document paths 206 is information that indicates a storage position of the document that includes the similar image data. In the similar candidate image information 203, the corresponding heat map 205 and document path 206 are arranged side by side with respect to the similar image 204. The document may be opened by clicking the document path 206.

The created search result output screen 200 is, for example, displayed on the monitor 14a or the like and provided to the user. The presentation information creation unit 106 may create the search result output screen 200 as a web page by using, for example, a structured document, and may be appropriately changed and implemented.

By referring to the similar candidate image information 203, the user may visually recognize the heat map 205 and the document path 206 for the similar image data determined to be similar to the search image 201 by the searching unit 104, thereby determining a validity or the like of the estimation by the machine learning model.

(B) Operation

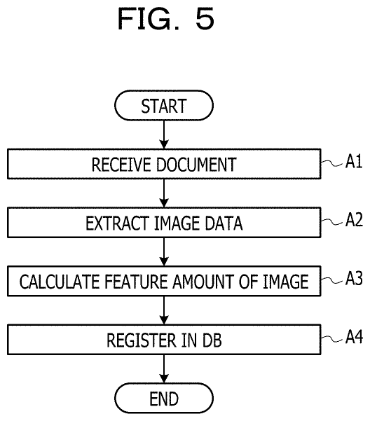

The processing of the document registration processing unit 103 in the information processing apparatus 1 configured as described above as the example of the embodiment will be described with reference to a flowchart (operations A1 to A4) illustrated in FIG. 5. The processing illustrated in FIG. 5 is executed before the start of the operation of the system or each time a new document is created.

In operation A1, for example, the document registration processing unit 103 receives a document including image data. For example, when a user, a system administrator, or the like inputs a folder storing a document or the document itself by using the keyboard 15a or the mouse 15b, the document registration processing unit 103 receives the input by reading the designated document.

In operation A2, the document registration processing unit 103 extracts the image data from the document received in operation A1.

In operation A3, the document registration processing unit 103 causes a feature amount of the extracted image data to be calculated by using the machine learning model of the neural network 102.

In operation A4, the document registration processing unit 103 registers the fess_id, site, filename, feature_vector, image_data, page_number, label, category, and file_format in the image DB 107 for each image data (entry registration). After that, the processing ends.

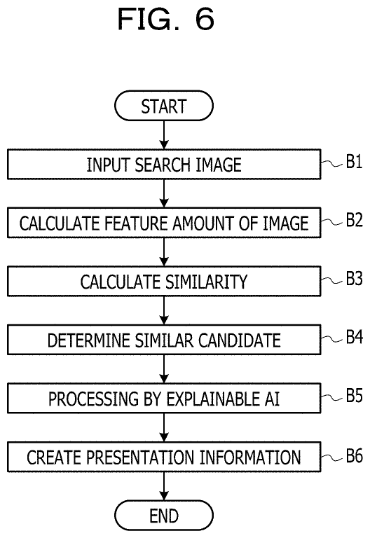

Next, document search processing in the information processing apparatus 1 as the example of the embodiment will be described with reference to the flowchart (operations B1 to B6) illustrated in FIG. 6.

In operation B1, the user inputs search image data to the information processing apparatus 1 by using the keyboard 15a or the mouse 15b. The input reception processing unit 101 causes the input search image data to be stored in a predetermined storage area such as the memory 12.

In operation B2, the input reception processing unit 101 causes a feature amount (feature amount vector) for the input search image data to be calculated by using the machine learning model of the neural network 102. In accordance with this, the neural network 102 calculates the feature amount of the search image data.

In operation B3, the searching unit 104 respectively obtains a similarity between the calculated feature amount of the search image data and each feature amount of the plurality of image data registered in the image DB 107.

In operation B4, the searching unit 104 searches for a plurality of pieces of image data (similar image data) of which the feature amount is similar to the feature amount of the search image data from the plurality of pieces of image data registered in the image DB 107. These pieces of similar image data may be referred to as similar candidates.

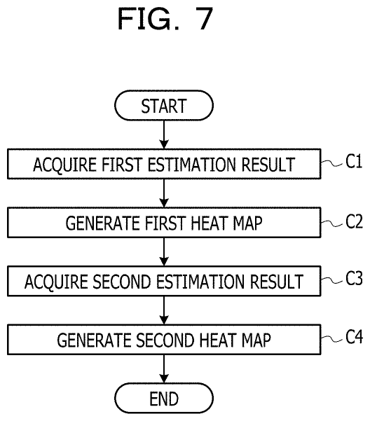

In operation B5, the explainable AI unit 105 generates visualization information by the XAI method using the neural network 102. The processing performed by the explainable AI unit 105 will be described later with reference to FIG. 7.

In operation B6, the presentation information creation unit 106 creates the presentation information (search result output screen) 200 by using the visualization information (the first estimation result, the first heat map, the second estimation result, and the second heat map) generated by the explainable AI unit 105, and provides the presentation information to the user. After that, the processing ends.

Next, the processing performed by the explainable AI unit 105 in the information processing apparatus 1 as the example of the embodiment will be described with reference to the flowchart (operations C1 to C4) illustrated in FIG. 7.

In operation C1, the explainable AI unit 105 inputs the search image data to the machine learning model of the neural network 102 to acquire the first estimation result.

In operation C2, based on the first estimation result, the explainable AI unit 105 generates a first heat map (third image) that represents a basis of the first estimation result by using the function as the Grad-CAM.

In operation C3, the explainable AI unit 105 respectively inputs the plurality of pieces of similar image data selected by the searching unit 104 to the machine learning model of the neural network 102 to acquire the second estimation results.

In operation C4, based on the respective second estimation results, the explainable AI unit 105 respectively generates the second heat map (fourth image) that represents bases for the respective second estimation results by using the function as the Grad-CAM. After that, the processing ends.

(C) Effects

As described above, in the information processing apparatus 1 as the embodiment of the present disclosure, when the user inputs search image data, the input reception processing unit 101 causes the neural network 102 to calculate a feature amount of the search image data. The searching unit 104 searches the image DB 107 for a document that includes similar image data similar to the search image data based on a feature amount of the search image data. Thus, a document that includes image data that is difficult to search in a natural sentence may be easily searched.

The explainable AI unit 105 creates visualization information by using an XAI method. For example, the explainable AI unit 105 inputs the search image data to the machine learning model of the neural network 102 to acquire a first estimation result. Based on the first estimation result, the explainable AI unit 105 generates a first heat map that represents a basis of the first estimation result by using a function as a Grad-CAM.

The explainable AI unit 105 respectively inputs the plurality of pieces of similar image data selected by the searching unit 104 to the machine learning model of the neural network 102 to acquire the second estimation results, respectively. Based on the second estimation results, the explainable AI unit 105 generates a second heat map that represents a basis of the corresponding second estimation results for each of the plurality of pieces of similar image data by the Grad-CAM.

The presentation information creation unit 106 creates a search result output screen (presentation information) 200 that includes these pieces of information. Accordingly, it is possible to present which area of the image the estimation result by the machine learning model is based on, visualize a basis of AI determination, and allow the user (operator) to trust the AI determination.

The explainable AI unit 105 creates visualization information (the first heat map and the second heat map) by using the neural network 102 used to calculate the feature amount vector of the image data stored in the image DB 107 and the feature amount vector of the search image data. For example, by sharing the neural network 102 for the search for the similar image data and the creation of the visualization information, the explainable AI unit 105 combines the search for the similar image data and the creation of the visualization information. Thus, the system design cost may be reduced.

(D) Others

The disclosed technique is not limited to the above-described embodiment but may be carried out with various modifications without departing from the gist of the present embodiment. Each configuration and each processing of the present embodiment may be selected as desired, or may be combined as appropriate.

For example, in the above-described embodiment, the explainable AI unit 105 creates the first heat map and the second heat map that indicate the basis for the estimation result by using the Grad-CAM, but the present embodiment is not limited thereto. For example, the first heat map or the second heat map may be created by using a guided Grad-CAM obtained by expanding the Grad-CAM, and may be variously changed.

In the above-described embodiment, an example in which the input data is image data has been described, but the present embodiment is not limited to this, and various modifications may be made. For example, the input data may be audio data or moving image data, and may be changed as appropriate.

In the embodiment described above, the information processing apparatus 1 has the function as the image DB 107, but the present disclosure is not limited thereto. For example, the image DB 107 may be constructed in an external DB server coupled via a network, and may be variously modified and implemented. The above-described disclosure enables a person skilled in the art to implement and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an image output program that causes a computer to execute a process, the process comprising:
inputting a first image to a machine learning model to estimate image data;
acquiring a feature amount of the first image and a first estimation result by the machine learning model to which the first image is input;
selecting at least one second image from a plurality of images, based on the feature amount of the first image;
inputting the second image to the machine learning model;
acquiring a second estimation result by the machine learning model to which the second image is input;
generating, based on the first image and the first estimation result, a third image that indicates an area of the first image that contributes to the first estimation result more than other areas;
generating, based on the second image and the second estimation result, a fourth image that indicates an area of the second image that contributes to the second estimation result more than other areas; and
outputting the third image and the fourth image.

2. The non-transitory computer-readable recording medium according to claim 1, the process further comprising:
outputting a document path of a document including the second image.

3. The non-transitory computer-readable recording medium according to claim 1,
wherein the process:
selects a plurality of second images that have higher similarities to the first image from the plurality of images, based on the feature amount of the first image,
generates the fourth image for each of the plurality of second images, and
outputs the third image and a plurality of the fourth images.

4. An image output method that causes a computer to execute a process, the process comprising:
inputting a first image to a machine learning model to estimate image data;
acquiring a feature amount of the first image and a first estimation result by the machine learning model to which the first image is input;
selecting at least one second image from a plurality of images, based on the feature amount of the first image;
inputting the second image to the machine learning model;
acquiring a second estimation result by the machine learning model to which the second image is input;
generating, based on the first image and the first estimation result, a third image that indicates an area of the first image that contributes to the first estimation result more than other areas;
generating, based on the second image and the second estimation result, a fourth image that indicates an area of the second image that contributes to the second estimation result more than other areas; and
outputting the third image and the fourth image.

5. The image output method according to claim 4, the process further comprising:
outputting a document path of a document including the second image.

6. The image output method according to claim 4,
wherein the process:
selects a plurality of second images that have higher similarities to the first image from the plurality of images, based on the feature amount of the first image,
generates the fourth image for each of the plurality of second images, and
outputs the third image and a plurality of the fourth images.

7. An image output apparatus comprising:
a memory; and
a processor coupled to the memory and configured to:
input a first image to a machine learning model to estimate image data;
acquire a feature amount of the first image and a first estimation result by the machine learning model to which the first image is input;
select at least one second image from a plurality of images, based on the feature amount of the first image;
input the second image to the machine learning model;
acquire a second estimation result by the machine learning model to which the second image is input;
generate, based on the first image and the first estimation result, a third image that indicates an area of the first image that contributes to the first estimation result more than other areas;
generate, based on the second image and the second estimation result, a fourth image that indicates an area of the second image that contributes to the second estimation result more than other areas; and
output the third image and the fourth image.

8. The image output apparatus according to claim 7, the processor further comprising:
outputting a document path of a document including the second image.

9. The image output apparatus according to claim 7,
wherein the processor is configured to:
select a plurality of second images that have higher similarities to the first image from the plurality of images, based on the feature amount of the first image,
generate the fourth image for each of the plurality of second images, and
output the third image and a plurality of the fourth images.
